(19) United States
(12) Patent Application Publication
(10) Pub. No.: US 2024/0330868 A1
(43) Pub. Date: Oct. 3, 2024

(54) HIERARCHICAL-RELATIONSHIP-BASED RESOURCE RESERVATION AND CLEANING

(71) Applicant: International Business Machines Corporation, Armonk, NY (US)

(72) Inventors: Joseph Arocho, Poughkeepsie, NY (US); Jonathan Fry, Fishkill, NY (US); Jennifer Anne Camacho, Wappingers Falls, NY (US); Nnaemeka Mcdonald Eluagu, Poughkeepsie, NY (US); Christopher Mazile, Brooklyn, NY (US)

(21) Appl. No.: 18/129,301

(22) Filed: Mar. 31, 2023

(51) Int. Cl. G06Q 10/1093; G06Q 10/0631

(52) U.S. Cl. CPC G06Q 10/1095; G06Q 10/06311

(57) ABSTRACT

A resource reservation system and method for scheduling and reserving of rooms for meetings of groups of individuals. The method determines an amount of time to allot between scheduled back-to-back meetings for an amount of cleaning of the room between the back-to-back meetings in order to minimize a risk of illness/dirtiness and minimize cross contamination of participants in the next group meeting in the room. The method determines a level of risk corresponding to determined hierarchical relationships between participants of the meeting/group and their personal characteristics. The hierarchical relationships include a determined relationship between and among the participants of a group and their relations with other non-participants of the group and any determined physical distances between participants that have determined relationships. Based on the computed level of risk score for that resource, the method determines an amount of cleaning and the amount of time allotted for the resource cleaning.

### FIELD OF THE DISCLOSURE

This disclosure relates to scheduling systems for reserving or scheduling meetings of groups of individuals in a shared resource such as a meeting room, and more particularly, to a system and method for more effectively reserving and cleaning a shared resource such as a meeting room intended to be successively occupied by different groups of individuals.

### BACKGROUND

Currently, as a result of COVID-19 pandemic, many cleaning standards have been put in place in private businesses, companies and organizations. Meeting rooms in a company can be scheduled for back-to-back meetings with little to no cleaning of the meeting room performed in between. The virus that causes COVID-19 (and/or other pathogens) can land on surfaces and it is possible for people to become infected if they touch their nose, mouth or eyes after touching these surfaces.

### SUMMARY

Accordingly, disclosed is a system and method for more effectively scheduling back-to-back meetings in a single meeting resource (e.g., meeting room) in a manner that minimizes an illness/dirtiness imprint upon the resource that is left by a first scheduled group.

In an embodiment, the system and method for more effectively scheduling back-to-back meetings by determining a type of cleaning that is required and a commensurate amount of time it would take to clean the meeting room between the back-to-back meetings.

The system and method allows for scheduling of back-to-back meetings in a manner that minimizes risk of illness or dirtiness and cross contamination between groups and participants in the second of the back-to-back group meetings, and ensures a suitable cleaning schedule sequence and cleaning time is accounted for.

In an aspect, the system and method automatically makes reservations for a shared meeting room resource in a room reservation system based on a computed “level of risk” associated with a room usage/occupancy of the meeting room by an earlier scheduled group. The system and method determines the level of risk for a reservation based on the hierarchical relationships for each participants of the group and the individual “level of risk” contact scores of the meeting group participants.

In one aspect, there is provided a method. The method comprises: receiving, at a hardware processor of a computing system, one or more requests for scheduling meetings of individuals in a group meeting in a determined meeting room; detecting, by the hardware processor, a first group meeting request and a second group meeting request scheduled for the same meeting room in succession; gathering, at the hardware processor, information about participants of at least the first group meeting, and determining one or more relationships between one or more participants of the first group meeting and non-participants of the first group meeting, and for each relationship, determining an associated physical distance measure between the participants of the relationship; computing, by the hardware processor, based on the determined one or more relationships and associated physical distance measures, a level of risk score representing a risk of illness or dirtiness; determining, by the hardware processor, an amount of time required for the meeting room to become clean between the first meeting and second meeting based on the level of risk score; and automatically scheduling a break of the determined amount of time between the first group meeting and second group meeting at the meeting room.

In a further aspect, there is provided a system. The system comprises: a hardware processor; a computer readable storage medium having program instructions embodied therewith, the program instructions executable by the hardware processor to cause the hardware processor to: receive one or more requests for scheduling meetings of individuals in a group meeting in a meeting room; detect a first group meeting request and a second group meeting request scheduled for the same meeting room in succession; gather information about participants of at least the first group meeting, and determine one or more relationships between one or more participants of the first group meeting and between participants of the first group meeting and non-participants of the group meeting, and for each relationship, determine an associated physical distance measure between the participants of the relationship; compute, based on the determined one or more relationships and associated physical distance measures, a level of risk score representing a risk of illness or dirtiness; determine an amount of time required for the meeting room to become clean between the first meeting and second meeting based on the level of risk score; and automatically schedule a break of the determined amount of time between the first group meeting and second group meeting at the meeting room.

There is further provided a non-transitory computer readable medium that includes programming instructions that, when executed by at least one hardware processor, configure the at least one hardware processor to perform the processes and/or steps discussed above.

The foregoing and other objects, features, and/or advantages of the invention will be apparent from the following more particular descriptions and exemplary embodiments of the invention as illustrated in the accompanying drawings wherein like reference numbers generally represent like parts of the illustrative embodiments of the invention.

### BRIEF DESCRIPTION OF THE DRAWINGS

FIG. 1 illustrates a resource reservation system for determining cleanliness in accordance with aspects of the disclosure;

FIG. 2 shows a general method of operating the resource reservation/scheduling and resource cleaning system of FIG. 1;

FIG. 3 depicts one embodiment of a method for scheduling a room for a group meeting and determining a level of cleanliness that is mapped into a cleaning procedure for cleaning the room before a next group meeting is scheduled;

FIG. 4 an embodiment for computing a contact or individual “level of risk” score as performed in the method of FIG. 3;

FIG. 5 conceptually depicts the computation of a group resource or meeting room “level of risk” score as performed in the method of FIG. 3;

FIG. 6 depicts an embodiment of a general method for determining a group/resource (i.e., meeting room) level of risk score as performed in the method of FIG. 3;

FIG. 7 depicts a graph-based embodiment for determining a participant i's contact score Nᵢ;

FIG. 8 depicts a further method implemented in real-time, at the scheduling/reservation system, for accommodating external or other real-time factors that can impact computations of individual contact or room level of risk score and consequently an amount of cleaning of a resource; and

FIG. 9 depicts a computing environment providing an example environment for the execution of at least some of the computer code involved in performing the methods of the embodiments described herein.

### DETAILED DESCRIPTION

The various aspects, features, and/or embodiments of a room/resource reservation system, method and/or computer program product for managing the booking and cleaning of meeting rooms will be better understood when read in conjunction with the figures provided. Embodiments are provided in the figures for the purpose of illustrating aspects, features, and/or various details of the systems and methods, but the claims should not be limited to the precise arrangement, features, aspects, embodiments, systems, modules, functional units, programming, instructions, methods, processes, techniques, and/or devices shown, and the arrangements, features, aspects, embodiments, systems, modules, functional units, programming, instructions, methods, processes, techniques, and/or devices shown may be used singularly or in combination with other arrangements, features, aspects, embodiments, systems, modules, functional units, programming, instructions, methods, techniques, processes, and/or devices.

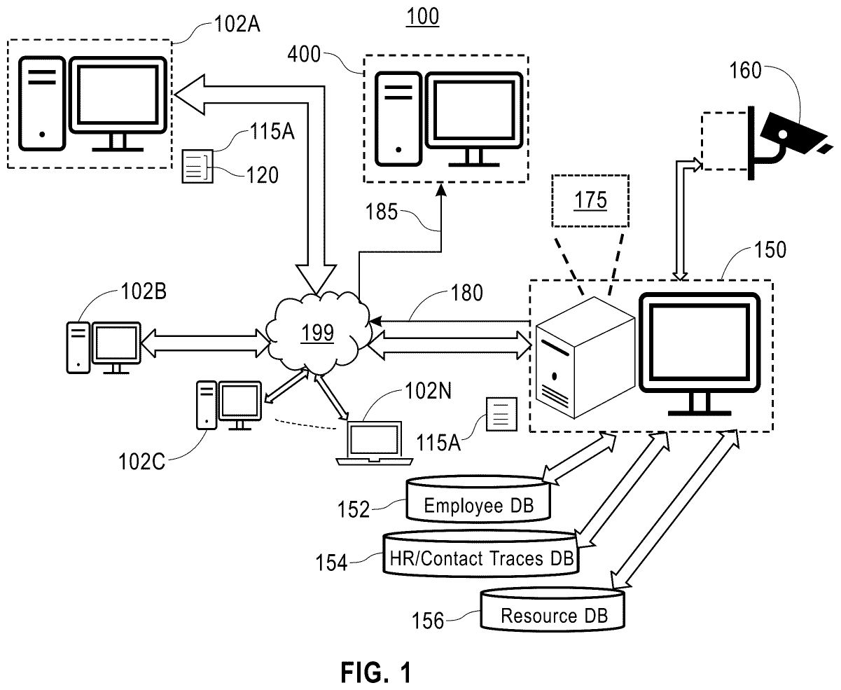

FIG. 1 depicts a resource reservation system 100 and method that enables scheduling and reserving of rooms and cleaning of resources 100 for multiple participants. The system includes a communications network 199 including multiple devices 102A, 102B, . . . 102N that can take many forms, for example, a computer, laptops, smart phones, personal assistants, terminals, a virtual computer, or virtual machine (VM), or a computing node.

Resource reservation system 100 includes a computing device such as a compute server device 150 running resource reservation and scheduling system software program 175 for enabling the scheduling and reserving of a resource, such as a room or place where people converge to meet, for a group meeting, and enabling a cleaning service to clean that room prior to a group meeting. In an embodiment, the amount of cleaning is determined according to a level of risk score 180 determined for that room as computed by the reservation system 100. This level of risk score 180 for the room is output from the reservation and scheduling system for receipt by a cleaning entity that is charged to clean the room according to a level of risk score. The cleaning time of the entity charged to clean the meeting room is determined and taken into account when reserving/scheduling that room for the next group at or near the next requested meeting time. This scheduling and reserving of a resource can be used to enable safe hybrid work procedures with multiple meeting rooms on a campus-type company setting. Further, the scheduling and reserving of a resource can facilitate reduced cleaning times and cost due to risk calculation based on hierarchical relationships among group participants.

With more particularity, as shown in FIG. 1, the room scheduling/reservation system server 150 is accessible by devices 102A, 102B, 102C . . . 102N over a communications network 199. Any device 102A, 102B, 102C . . . 102N can connect to the resource reservation/scheduling and cleaning of resources system 100 either through a web-based portal or a distributed application at a user or participant's device (hereinafter referred to as “client device”). In embodiments, the devices 102A, 102B, 102C . . . 102N include application software that provides an interface enabling the users to interact with the resource reservation/scheduling and cleaning service system 100. In embodiments, the resource reservation/scheduling and cleaning service system 100 will allow a user to reserve a resource such as a room in building that can accommodate a group meeting of multiple participants and ensure that the room is sufficiently “clean” based on determined criteria that ensures minimizing a spread of illness/infection/dirtiness. The resource reservation/scheduling and cleaning of resources system 100 more effectively reserves and cleans a shared resource, e.g., a meeting room.

In further view of FIG. 1, for use in computing the level of risk score for an individual or group, the server 150 can access information in various databases of the organization including. e.g., an employee database 152, or an organizational chart that is consulted to obtain the hierarchical relationships of a participant indicated in a requested room resource. The organizational chart can include office/seating locations of the various employees from which nominal physical distances between the participants of the group can be determined and any environment factors, e.g., partitions, walls, cubicles, that separate participants.

In further view of FIG. 1, the server 150 can access a human resource platform or like human resources data base 154. Such database 154 can keep track of health-related information for the employee and can include or implement services of a contact tracing platform implemented for the organization. In an embodiment, the information accessed by database 154 that is used to compute the level of risk score for an individual/group can include, but is not limited to: a comorbidity factor such as a health condition of a participant; a current illness or sick day of a participant; a recent vacation abroad by a participant; a degree to which the participants have recently physically been in close contact with each other (e.g., as determined via contact tracing, or by an organization chart that governs the participants).

Further, the server 150 can access a resource platform or data base 156 which can provide the information about the resources used by individual(s)/group for the meeting. Such information can be further used in computing the level of risk score computation for an individual or group. This information may include but is not limited to: one or more physical elements of the meeting room that invite significant (e.g., very close in proximity) physical contact, and the layout of the meeting room which defines whether or not the participants are likely and/or able to spread out or cluster within the meeting room.

In embodiments, the server 150 may include program modules such as one or more Application Program Interfaces (APIs) for enabling communication and integration with other applications to obtain relevant information used for determining the level of risk score. Such APIs are provided to enable server interfacing with, e.g., an employee tracking/ID application, a scheduling software application, a cleaning service platform/server, any services associated with a cloud computing platform, contact tracing service platform, e-mail service platform, social networking services platform(s).

In a further embodiment, a video camera, a camera tracking system or like surveillance system 160 interfacing with an employee tracking/ID application running at server 150 can be used to track a presence and/or absence of the participant at a location and actions of the participants in order to determine/modify the computed risk score.

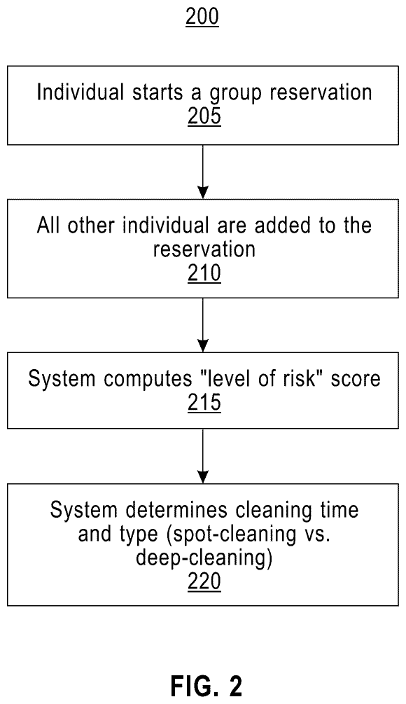

FIG. 2 shows a general method 200 of operating the resource reservation/scheduling and resource cleaning system 100 of FIG. 1. In an embodiment, at 205, an individual desirous of reserving a resource, e.g., a meeting room, for a group, will initiate a reservation for a meeting room via the resource reservation/scheduling system 100 through a user device 102. For example, referring back to FIG. 1, through a web-based portal or through a distributed application at a participant's device 102A, the participant at device 102A populates a web-page form or data structure 115A with information 120 indicating a particular resource to be reserved, e.g., a room in a building, the requested time of the meeting, the planned duration of the meeting, and the number and names of participants to attend the meeting.

Continuing in FIG. 2, at 210, the other individuals to that reservation, will be contacted to confirm their participation similar to how participants are invited to an event in a calendar program and the other individuals of the group will accept that they will participate in that event. Then, at 215, based on the meeting information 120, the resource reservation and scheduling system software 175 will take all of the individuals indicated as attending this meeting and invoke methods to calculate a “level of risk” score 180 for that group of participants for that time in the requested meeting room to be reserved. This level of risk score 180 is determined, in part, based on information such as hierarchical relationships determined for each individual in the meeting. In an embodiment, other information used to compute the contact level of risk score include the physical distances between the individual and others in that person's department. This data is determinable based on company organizational charts, seating charts, etc. that are available and accessible by the scheduling/cleaning system program run at server 150. Other factors that can be taken into account include any special information e.g., that individual's commuter group, family relationships, current illnesses, characteristics, etc. . . .

Finally, at 220, FIG. 2, based upon the reserved room's determined final “level of risk” score 180, the method of the resource reservation/scheduling and resource cleaning system 100 includes the determining of a cleaning time or “break” time and cleaning type, e.g., a “spot” cleaning versus a “deep” cleaning performed during the break time. In a non-limiting example, given a level of risk score limits between 0 and 1, a final room risk score of 0.75 or greater may require a deeper cleaning (e.g., sanitizing) of the meeting room, while a final room risk score of less than 0.25 may warrant only a “spot” cleaning and a final room risk score in between 0.5 and 0.75 may require a standard or regular cleaning. The system is configurable to map the level of risk score to a cleaning/break time amount and a cleaning type.

In embodiments, the room reservation method can schedule a second, subsequent group meeting time for any second group at an immediate successive time in that resource that will be delayed (i.e., delayed) from ending time of the first received requested meeting time to allot for the break time (a time cleaning period between the first and second meeting) and the determined room cleaning type to be performed during the break time.

Subsequently, this determined cleaning amount/type is communicated as a message or signal 185 to a cleaning service associated with the company that functions to physically clean the room prior to the scheduled meeting time.

In an embodiment, the system can further ensure an automatic locking of the meeting room after participants of the first meeting leave for the duration of the break time whether or not a cleaning is performed.

Referring back to step 215, FIG. 2, in an embodiment, the computation of a level of risk score 180 involves obtaining and determining the biographical information about people in a company and hierarchical relationships associated with each participant of the meeting/group. A hierarchical relationship associated with a participant of the meeting/group includes a determined relationship between the participants members of the group (e.g., managers, group leaders, and workers that report to each), a determined special relationship of the participants with other non-participants of the group (e.g., sharing a carpool, family members), and a determined relationship with a participant(s) of a later scheduled group meeting to be held in the same resource, i.e., meeting room in time succession (back-to-back).

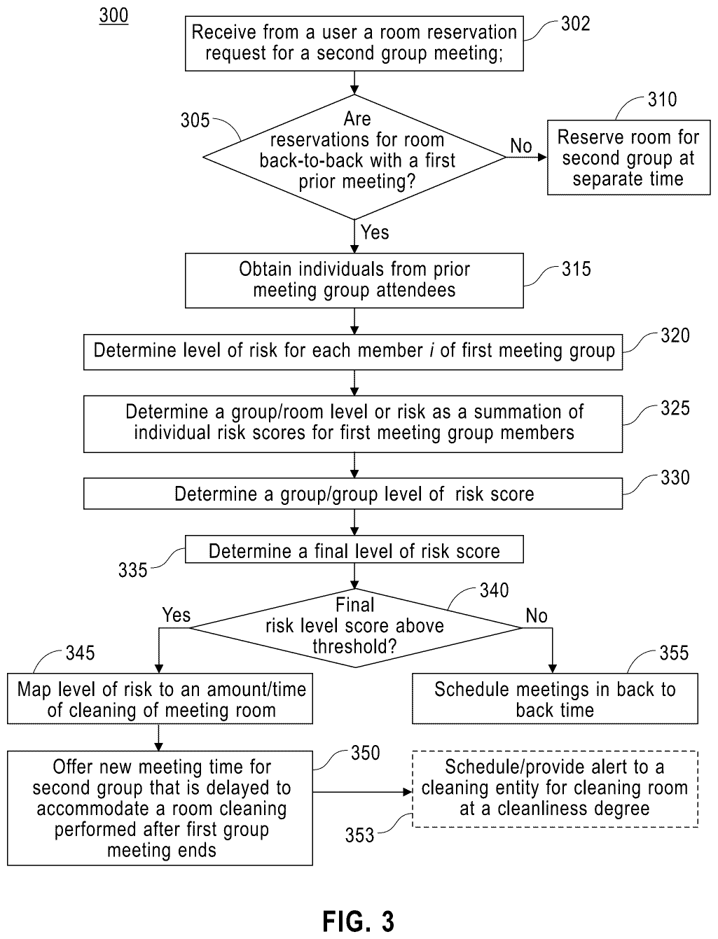

FIG. 3 depicts a method 300 for scheduling a room for a group meeting and determining a level of cleanliness that is mapped into a cleaning procedure for cleaning the room using a cleaning service after the group meeting is over. This method is run at the server 150 under control of the resource reservation and scheduling system software 175. A first step 302 represents the first step of receiving a room reservation request for a first group meeting at a particular room at a requested time. This reservation request can be received at the system server via a web-based application run a user's computer or mobile device or can be received as a regular e-mail message.

Then, at 305, FIG. 3 a determination is made as to whether the recent room reservation request for first group meeting immediately succeeds another prior scheduled group meeting (i.e., is back to back with another meeting). If, at 305, if it determined that the recent room reservation request for a group meeting does not immediately succeed another prior scheduled group meeting, then the scheduling software can reserve rooms for two groups at the requested time (i.e., not back to back with another meeting). Otherwise, if the reservation request is for a time successive to another meeting time, in approximate temporal succession, then the process proceeds to 315 where the prior group meeting participants are determined. A reservation request that is in approximate temporal succession to another is defined as a second meeting that is requested approximately back-to-back (in time) at the end of a first meeting.

For example, in an embodiment, responsive to the scheduling request for a group meeting, the various invitees can respond with e-mails or via a web-based interface either with an affirmative indication that they can attend the meeting at the requested time, or decline attendance, or attend by remotely logging-in such as through a virtual private network. At 315, the participants that respond in the affirmative is determined. Alternately, if the meeting is currently in attendance, the participants of the meeting in the requested room is determined such as by badge sensor, or surveillance system camera, or any log-in device.

Before scheduling the second group meeting, there is first determined a level of risk for that room based on the first group. Based on that determined level of risk, there is determined a level of cleaning required and an amount of cleaning time required for that room before the next group can be scheduled to meet at that room.

To determine the room level of risk, there is first determined the level of risk for each individual i in that first group. In embodiments, the level of risk score can be a normalized value ranging from limits being 0 and 1, or 0 and 10, for example. The determining a level of risk for each member i of the prior (first) group meeting is show at step 320, FIG. 3 where, for each member from the prior meeting group, there is determined an individual's level of risk. This is determined by biological information of individuals and hierarchical relationships of the members and other individuals that that person can interact with. Then, at 325, based on each group member's individual risk score, there is determined a resource or room level of risk. In an embodiment, the room level of risk is determined as a summation of individual risk scores for the first meeting group members.

The process then proceeds to step 330, FIG. 3, to determine a group/group risk score based on whether there is any degree of overlap of group members between the first and second group meetings.

Then, continuing at 335, there is determined a final level of risk score computed as a summation of one or more of the determined room level of risk and any determined group-to-group risk level.

Continuing to 340, FIG. 3, the system determined whether the final risk level is above a pre-determined threshold. If the final level of risk score is not above the threshold, this indicates that there is no cleaning necessary between the first group meeting and the requested second group meeting. Thus, at 355, the system can schedule the second group meeting in succession without cleaning of the room in between. Thus, the second group (of the current request) will be scheduled to meet at the requested time immediately after the first group meeting ends (i.e., back-to-back) with no cleaning intervention.

Otherwise, at 340, FIG. 3, if the final level of risk score is determined to be above the threshold, this indicates that there is a degree of cleaning required between the first group meeting and the requested second group meeting. In an embodiment, at 345, the final level of risk score for that second meeting is mapped to a degree of cleaning, e.g., light or spot cleaning, a “standard” or regular cleaning, or a deep or heavy/industrial sanitizing cleaning. Based on this degree of cleaning, there is determined an amount of time for a cleaning service to provide the determined level of cleaning after the first group meeting ends. As an example of the system using the level of risk score to determine how much cleaning time should be allotted and what type of cleaning needs to be done between meetings, it is the case that a meeting room is going to require way less cleaning for a meeting with 5 people than would be required for an “all hands” meeting where the entire department is invited.

Continuing at 350, the second group meeting can be scheduled after the first group meeting however, delayed for the amount of time it takes a cleaning service to clean the room based on the determined level of cleaning. This second group meeting time is offered to the room reservation requestor and if acceptable, the second group meeting is scheduled in the scheduling system after the first group meeting. The new meeting time is the delayed time by the determined amount of cleaning time necessary to clean the room between the first and second meetings at the degree of cleaning required. In an option, or in addition, at 353, the system 150 can schedule a timing of a company cleaning entity or janitorial service for cleaning/sanitizing a meeting room, at the degree of cleanliness required. The system 150 can use of an autonomous cleaning service. As an alternative to physically cleaning the meeting room, or in addition to a physical cleaning, the system can enforce a “break” period between meetings or a “decay” time period in which the meeting room is rendered inaccessible. Such an option can cause a locking of the meeting room to render the meeting room inaccessible, e.g., for a “decay” time period. Optionally, or in addition, the system 150 can generate an alert message or signal 185 that can go to any third party cleaning entity, e.g., outside the company, for retention in any cleaning application circumstance.

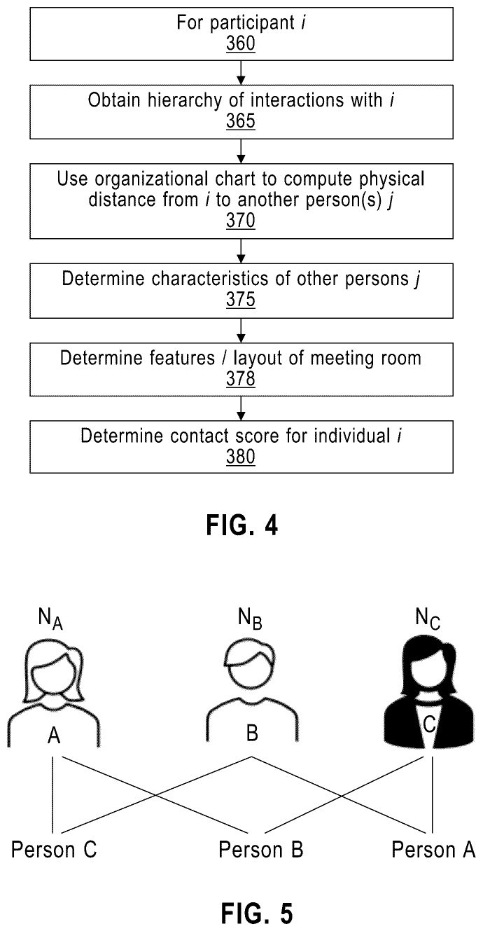

FIG. 4 depicts an embodiment for computing a contact or individual “level of risk” score as performed at step 320, FIG. 3. This individual risk or “contact” score for a participant i is initialized at 360 and at 365, the system determines a hierarchy of the interactions or relationships with participant i. In an embodiment, a hierarchical relationship associated with a participant is determinable by obtaining information for the participant including, but not limited to: a team that the individual participant is a part of or members that participant works with, who the manager of the participant is, who the participant sits next to, etc. . . . In an embodiment, at step 370, FIG. 3, the system server 150 can access an employee database or access the company's organizational chart in a manner to determine a hierarchy of contacts or interactions between participant i and any other individuals j and the nature of the contact or interaction between i and j. More particularly, the obtained information for determining a hierarchical relationship includes estimating a physical distance between the participant and other group participants. For example, this nominal physical difference can be estimated by ascertaining who is in their direct first line department, or who sits immediately adjacent to them, or who shares an office or a cubical with that individual (e.g., as opposed to sitting in an open area). This individual contact score N for participant i further includes, at 375, determining the characteristics of the another individual j. These characteristics can include but are not limited to biological information of the participant such as: a comorbidity factor such as a health condition of one participant; a current illness or sick day of the participant (e.g., a recent diagnosis of COVID-19); other information such as a recent vacation domestic or abroad by the participant, a commuter/carpool group that the participant belongs to, a family relationship with another employee, and a degree to which the participants have recently physically been in close contact with each other (e.g., as determined via a contact tracing service).

Continuing to 378, FIG. 3, the system server 150 can access a resource database 156 in a manner to determine feature or characteristic of the meeting room. For example, this factor can include a layout of the meeting room, or a characteristic that forces participants to cluster, or spread out, sit or stand, etc., in the meeting room.

Continuing to 380, FIG. 3, the system server 150 determines the contact level of risk score N for an individual of the group meeting based on the ascertained information from each of the employee database 152, human resources platform 154, and/or resource database 156. For example, the risk score value N determined for an individual can be based on several criteria, including but not limited to: biological information, hierarchical relationships of company employees, nominal physical distance measures between participants while working, presence of any partition(s) between participants while working, and other characteristics/factors. The score can be a simple tally of connections between nodes, or can be a sum of weights of connections on nodes (employees)(e.g., half-weight connection). Here, the connection corresponds conceptually to an illness transmission potential.

As an example, the individual or contact risk score can be a value, e.g., between 0 or 1, 0 to 10, or any other limits, based on the ascertained information. An office worker who only interacts with one or two people yet carpools with another group of workers or is related to someone in the office can have a higher level of risk score N than one who does not. In another example, a manager who comes into contact with many members of a team or group can have a high individual score N. An office worker who only interacts with one or two people may have a lower individual level of risk score. Further, the score can be a simple tally of connections between nodes, or can be a sum of weights of connections on nodes (e.g., half weight connection); the connection corresponds conceptually to transmission potential

In an embodiment, the individual person has a regular or initial contact score of N and, in embodiments, the computed value of N can change based on the current circumstance of the individual. In embodiments, the contact score decays back to N for an individual. For example, at each new day, the level of risk value N for an individual can be reset based on that individual's current circumstance.

FIG. 5 conceptually depicts the computation of a group resource or meeting room “level of risk” score as performed at 325, FIG. 3. Here, each person of that first group initially has a regular (or initial) contact score of “N” which is computed, e.g., based on the personal relationships and hierarchical relationships and physical distances/current illnesses.

The computation of a resource (e.g., meeting room) risk level score or a group risk score at 325, FIG. 3 can include obtaining information such as, but not limited to: a number of participants of the two meetings, a degree of overlap of participants between the two meetings, characteristics of the participants, features and a layout of the meeting room, and a nature of the two meetings.

As shown in FIG. 5, there is depicted an example the calculation of “level or risk” score for the group/resource (i.e., requested meeting room). In this example calculation, there is shown three individuals of the group (e.g., individuals A, B, C) who want to reserve the meeting room. The group score “N1” is determined by summing the weighted connections of each individual. The individual weighted score for each individual A, B C is denoted as N_{wA}, N_{wB}, N_{wC} respectively, where w is the weight attributed to this relationship. The weighted connections are determined by each person's relation to the other in the meeting. The level of risk score and each individual's contact score is then updated to reflect N1 as shown below as a sum of the weighted individual scores of the participants:

$$N 1 = \sum ( {N}_{wA} , {N}_{wB} , {N}_{wC} )$$

FIG. 5 further depicts obtained information for persons A, B and C who want to book a meeting room. In an example, it is determined that Person A and Person B work with each other, but neither person A or B work with Person C. In the example, it is determined that Persons A and B each have an initial contact score of 2, i.e., N_{A}=2 and N_{B}=2, while Person C has an initial contact score of N_{C}=1. Because persons A and B work with each other, Person A's contact score, N_{wA} will be the sum of their own contact score plus Person C's contact score, i.e., N_{wA}=N_{A}+N_{C}=2+1=3. Similarly for Person B, Person B's contact score will be the sum of their own contact score plus Person C's contact score, i.e., N_{wB}=N_{B}+N_{C}=2+1=3. Because Person C doesn't work with anyone in the meeting, their score will be the sum of their own score plus the scores of each of Persons A and B, i.e., N_{wC}=N_{A}+N_{B}+N_{C}=2+2+1=5.

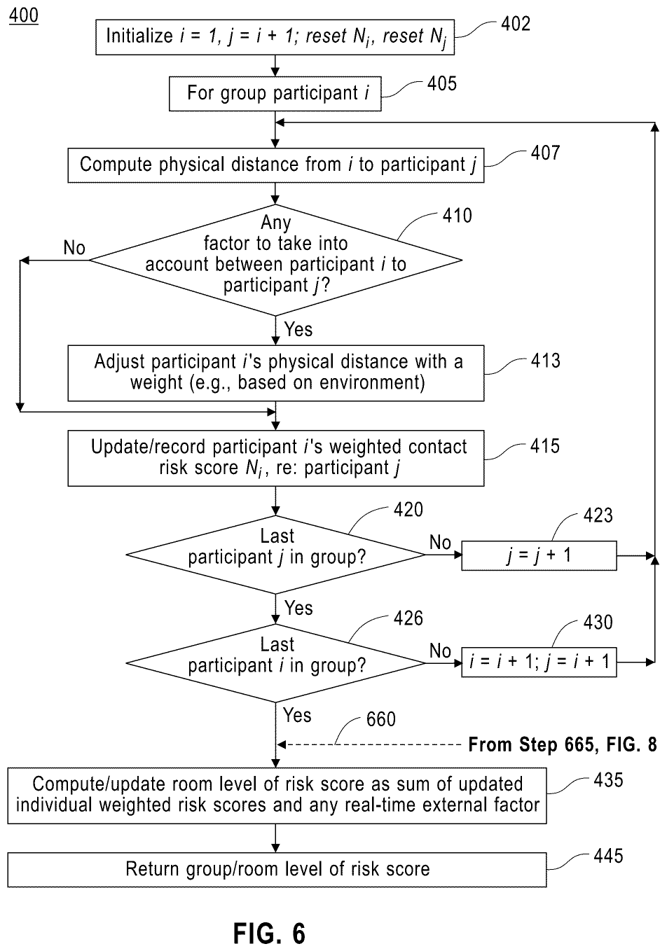

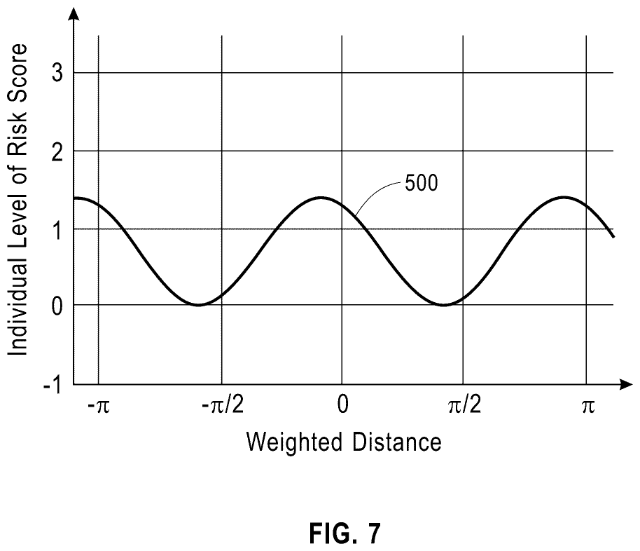

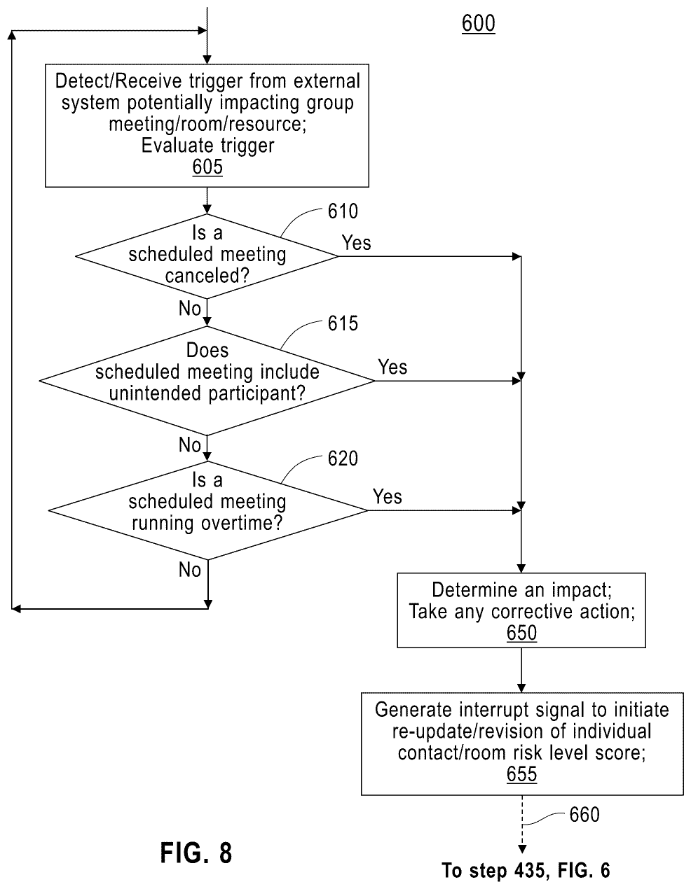

FIG. 6 depicts an embodiment of a general method 400 for determining a group/resource (i.e., room) score, i.e., the level of risk score N1, as performed at 325, FIG. 3. This group score N1 is computed as a summation of weighted connections with the weighted connections calculated by each individual's relation to one another and other factors. The level of risk score and each individuals' contact score is updated to reflect N1.

As shown in FIG. 6, at step 402 there is depicted the initializing of indices i representing a first individual/participant of the group, and indice j for pointing to every other individual/participant of the group. For example, these indices are set to i=1 (e.g., participant 1), and j=i+1 (e.g., participants 2, 3, . . . ). Additionally initialized or resent to their regular values are the computed individual contact values for the participants, i.e., Nᵢ and Nⱼ. Then, at 402, FIG. 6, for the first group participant 1, the process proceeds to step 407 where the system obtains the relevant information for determining a physical distance between participant i and participant j. Then, continuing to 410, a determination is made as to whether any factor to take into account between participant i and participant j. As an example, any of the factors such as special relationships between the participants or special characteristics of the participants, any relevant environmental features/layout of the meeting room, or any real-time external factors (a squatter who is not part of the group attends meeting) etc. can be ascertained. If, at 410, there are no factors to take into account, the process proceeds to step 415 where the participant's i's contact score Nᵢ is updated and/or recorded at 415 for use in future computations. Otherwise, at 410, if there are determined special additional factors, the distance measure between participant i and participant j can be adjusted or weighted based on the additional factor(s). Then, the process will proceed to step 415 where the participant i's contact score Nᵢ is updated and/or recorded.

FIG. 7 depicts a graph-based embodiment for determining a participant i's contact score Nᵢ. In particular, FIG. 7 shows an individual risk score graph plotting a curve of a participant's contact score Nᵢ (Y-axis values) as a function of the participant's weighted distance value determination (X-axis values ranging, for example, between 0 and π/2) between another participant, e.g., participant j. In an embodiment, the X-axis values are convertible from a physical distance, e.g., in feet or meters. In FIG. 7, the plotted curve 500 shows that the lower the distance value (i.e., relationships/distances closer to 0) between two participants results in computing a higher level of risk score, while the greater the distance value (i.e., a further apart relationships/distances closer to π/2) between two participants results in computing a lower level of risk score. In an embodiment, a threshold distance value such as between 15 feet-17 feet can indicate a close distance (increased level of risk), while a distance value greater than 17 feet can be a further distance (decreased level of risk) The curve 500 of FIG. 7 is generally governed according to the following relation:

$$y = αsin ( \frac{( x - h )}{b} ) + k$$

where α (amplitude), x (the determined distance), h, b and k (y-intercept) are variables that can be programmed to achieve a level of risk score level sensitivity. In a non-limiting example, for an average risk score level sensitivity computation, variable a can have a value of −0.7, variable h can have a value of 0.5, variable k can have a value 0.7.

Referring back to step 420, FIG. 6, the method then determines whether participant j is the last participant of the group. If the participant j is not the last participant of the group, the process proceeds to step 423 where the value of index j is incremented (j=j+1). The process will then revert back to step 407 where the process steps 407-415 are repeated based on the relationship between the participant i and the new participant j. This iterative process steps 407-423 for revising/updating participant i's contact score is repeated until the last other group member participant j is processed at 420, at which time, the process proceeds to 426, FIG. 6 where it is determined whether the last participant i in the group has been processed. If, at 426, it is determined that the last participant of the group has not been processed, then the process proceeds to 430 in order to increment the index i (i.e., i=i+1) in order to process the second person of the group (e.g., for next iteration i is participant 2) and to increment the index j (i.e., j=i+1) to determine the next participant i's relation with the remaining group members relative to participant i=2 (e.g., participants 3, 4, . . . ). Then, after incrementing indices i, j, the process returns to step 407 where the iterative process steps 407-423 are repeated based on the relationship between the participant i and each of the remaining participants j in order to update participant i's contact score Ni.

Otherwise, at 426, if it is determined that the current participant i being processed is the last participant, then the process proceeds to 435 where the room level of risk score “N1” is computed/updated as the summation of each of the participant's updated individual i's weighted contact risk scores Nwi according to:

$$N 1 = {\sum }_{i = 1} {N}_{wi}$$

where w is a weight based on relationships/additional factors. Then, at 445, FIG. 6, the system server 150 returns the computed room level of risk score N1 for mapping to a degree of cleanliness for cleaning the reserved room after the first group meeting ends.

In an embodiment, a further group-to-group level of risk score can be determined. This group-to-group score N2 is a modification of the group level/room risk score N1 to take into account a degree of overlap between the first and second groups at the requested back-to-back meeting. In an embodiment, the group-to-group score represents the level of risk calculation based on the group's level of risk score as well as the level of risk score from the previous group reservation. The group-to-group score is calculated just like the group score N1 (such as for Persons A, B and C in the example of FIG. 5 or the generic group described in the method of FIG. 6) and determined largely based on determining who works with who, who sits next to who, etc. and the level of risk calculation of the previous meeting.

The system server 150 further calculates the weighted level of risk by determining the relationship between each person in the previous meeting and the second requested meeting. And finally take the sum of that to get N2, i.e., that includes the sum of weighted connections and the weighted level of risk score of the previous group. This calculation may include determining a degree of overlap of participants between the first meeting and second meetings. For example, a risk score is reduced when the overlap of the participants between the two meetings is greater than a threshold. The final level of risk score and each individuals' contact score in this reservation is updated to reflect N2.

Generally, the “group-to-group” level of risk score N2 is a calculation of a union of the risk score N1 as determined at 435, FIG. 6 as determined for the first meeting group and each of the individual scores of the new participants of the second meeting group, e.g., persons X, Y and Z where N_{wX}, N_{wY}, N_{wZ} are the respective individual contact scores determined for second meeting group participants X, Y and Z. This is a computation according to:

N2=Σ(N₁,N_{wX},N_{wY},N_{wZ})

where w is a weight based on participant's relationships/additional factors and N1 is the group level risk of the first prior group meeting. Thus, in an embodiment, the system server 150 can return a computed final risk score N2 that can be used for mapping to a degree of cleanliness for cleaning the reserved room after the first group meeting ends.

As an example group-to-group level of risk computation, it is assumed persons A, B are members of a first meeting who do not work together. This scenario creates a bunch of temporary first order connections such that it's the union of N_{wA} and N_{wB} (e.g., Σ(N_{wA}, N_{wB})). This temporarily imprints on the room/resource as N1=(e.g., N-Union(Nw_{A}, Nw_{B}))=N−U(Nw_{A}, Nw_{B})), and remains until end of a “decay” time (i.e., waiting a long time after a meeting ends without cleaning) or cleaning the room/resource. This is modified by interactions with people beyond the N regular contacts. For example, a next group to book the same room is person C, will create connections such that the second (new) contact group will have a score of N_{wC} plus either full or partial strength links to group N−U(Nw_{A}, Nw_{B}). For example, there is computed a full strength imprint as if C were in the room with A and B if no cleaning happened, thereby computing for person C a contact score: Σ(N_{wA}, N_{wB}, N_{wC})=N-Union(Nw_{A}, Nw_{B}, Nw_{C}) and the room N1 getting the same. Alternately, there is computed a partial strength imprint with a quick cleaning performed at the room and person C have contact score: Σ(N_{wA}, N_{wB}, N_{wC})=N−U(partial-N_{wA}, partial-N_{wB}, N_{wC}).

In a further embodiment, the room level of risk score is reset to no imprint, and changed to contact group C (N_{wC}) if a full cleaning was provided.

FIG. 8 depicts a further method 600 implemented in real-time, at the scheduling/reservation system server 150, for accommodating external or other real-time factors that can impact computations of individual contact or room level of risk score and consequently an amount of cleaning of a resource. The additional method of FIG. 8 accommodating external factors addresses specific instances of a group meeting running over time of the scheduled end, or if a scheduled meeting for a group at a resource/room should become canceled at the last minute or when an unexpected attendee (e.g., “squatters” or like unintended participants) joins or drops out of the group. This method further addresses the “oscillating” meeting room problem when successive reserved meeting groups, e.g., Group A and Group B (or partials thereof), appear to be swapping between a first room (e.g., Room 1) and a second room (e.g., Room 2).

In an embodiment, at 605, FIG. 6, such a system can be triggered via receipt of an external signal indicating a particular non-intended issue. For instance, prior to the meeting, an e-mail may be received from the requestor that a first of the scheduled back-to-back group meeting is being/has been canceled. The system can evaluate this e-mail or any received trigger at 605. The evaluation may determine at 610 whether the meeting has been canceled; or determined at 615 whether the scheduled meeting includes an unintended participant such as determined by an employee identification system employing use of a camera or log-in badge system 160 used to verify attendees at a group meeting; or determine at 620 whether the scheduled meeting is running overtime the scheduled end of the group meeting. If none of these triggers are received, then the process 600 is idle, waiting to detect/receive any trigger signal, and the process returns to 605.

Otherwise, returning to step 610, FIG. 6, if a trigger is received that the meeting is canceled, then the process proceeds to step 650 where the system determines any potential impact and the system takes any suitable corrective action. For example, at 610, if it is determined that a scheduled group meeting has been canceled, then a determined impact can be that there does not have to be allotted a cleaning time for that resource after that canceled meeting. Thus, in response, an alert of further signal 185 can be generated by system server 150 to the cleaning entity/cleaning service to cancel the scheduled room cleaning reservation. As a consequence, this can creates an opening for scheduling another meeting and thus may modify cleaning requirements for later any later group meeting booking(s). Further, continuing at step 655, the impact of real-time trigger received from the external system can result in invoking a re-updating or revision of the contact/room risk level score computation. As a consequence of this, the system can generate an interrupt signal 660 to initiate an update of the room/resource risk level score as shown as a received interrupt signal 660 at step 435, FIG. 6, which received signal can be used to trigger the system to update a contact risk score or room level risk score. For example, if a video camera system detects a cancellation or absence of one or more participants of the first meeting that was supposed to be physically present, the room risk score can be lowered as a result of the one or more participants having canceled. Further, the duration of the break time between the first meeting and second meeting can be lowered as a result of the risk score being lowered.

Thus, in an example, an original schedule for group meetings includes: a meeting Group A has room at 9 AM, with a scheduled cleaning 10 AM, and a back-to-back next meeting of Group B at 11 AM in the same room, and a cleaning at noon, and a further group meeting of a Subset of Group A participants at 12:30 PM. Group B submits a cancelation of their 11 AM meeting. Thus, the scheduling system may seek to schedule the Subset A group meeting at 12 noon as the cleaning at noon would no longer be required. Otherwise, as no cleaning would be necessary after Group A meeting, it possible to re-schedule Subset Group A meetings as back-to-back bookings with Group A (Group A (meeting at 10 AM) and subset Group A participants (re-scheduled after first meeting ends at 11) without any cleaning.

Otherwise, returning to step 615, FIG. 6, if a trigger is received that the meeting includes an unintended participant, then the process proceeds to step 650 where the system determines any potential impact and the system takes any suitable corrective action. For example, at 615, a camera- or badge-employee identification system 160 can determine that a scheduled group meeting includes an unintended participant, or if it is determined that an intended group participant has decided to dial-in and attend the meeting remotely (rather than attend locally) then it is determined that this can impact the group/room level of risk score. In an instance of added unintended participants, it may be determined that more cleaning time would be necessary. In an embodiment, the system may suggest some of the people to be remote. If enough people has not joined or dialed in remotely, then the room reservation may be canceled.

In an embodiment, a person that scheduled the meeting could update the attendees list (e.g., add last minute joins or remove last minute drops) in the system. In one consequence, the level of risk calculation can be updated in real time. Further, it may be determined whether or not the booking should be cancelled because the risk becomes beyond a threshold or otherwise, update the time needed for cleaning.

As a further example, upon detecting that one or more participants of the first of the two group meetings that was supposed to be physically present instead cancels and/or dials in remotely, the system can responsively determine that a risk score of the first meeting is lowered as a result of the one or more participants having canceled and/or dialed in remotely. This may necessitate a reduction of the duration of the “break” time allotted between the two meetings as a result of the risk score being lowered.

Otherwise, returning to step 620, FIG. 6, if a trigger is received that the scheduled meeting is running overtime, then the process proceeds to step 650 where the system determines any potential impact and the system takes any suitable corrective action. For example, at 620, if it is determined that a scheduled group meeting is running over time, then one consequence is to determine the impact of any following meeting(s). For example, it may be the case that if the second group is the same as the first group (running overtime) or a subset of the same first group, then there would be no cleaning impact. Otherwise, for example, if the second group is partially overlapping with the first group (running overtime) or is a subset of the same first group, then there may be a minimal cleaning required. Depending upon the amount of partial overlap, the system may suggest that certain invitees of the second group do not physically attend, but rather attend remotely. Otherwise, for example, if the second group is a completely different group and does not overlap at all with the first group (running overtime), then there may be required a more deeper cleaning required and the meeting may be delayed or the start time of the second group meeting pushed back in time. Otherwise, or in addition, there may implemented a notification system to notify participants of the second group when that room/resource is ready for them. Thus, as a further example, upon detecting that a first meeting of the two meetings is running late, the system can autonomously convert the physical meeting into a remote meeting in response to the first meeting running late and a risk score being above a threshold.

FIG. 8 is further configured for detecting group meeting squatters, e.g., how to record non-requested resource usage(s). In this embodiment, presence of squatter can inherently impact the risk score of grouping, room imprint/score (some relation to prior group usage and or cleaning) and the final cleaning tiers (no clean, spot clean, deep clean). Such detection can occur by the system software being tied to a camera system configured to monitor the number of people in the meeting room at a given time. In an embodiment, any meeting room “squatter(s)” should be required to enter their information into the system software prior to entering the space. This will kick off a level of risk calculation and a cleaning team can be notified. IN an embodiment, any unidentified squatter can be logged in as not a member of any group and incur a larger penalty (compared to a known participant) for cleaning. In this scenario, any camera/identification system employed may require some tracking/filtering to deal with shadows, etc.

FIG. 8 is further configured for detecting the oscillating meeting room problem where Group A and Group B (or partials thereof) appear to be swapping between rooms (e.g., Rooms 1 and 2). Here, for example, a first group, e.g., group A meeting, is 20 people, followed by a second subset A of 5 people. Rather than staying in the same room the intuition is for them to book a smaller room. Meanwhile Group B was in a smaller room, and only went to the bigger room because it was available. This creates two cleaning scenarios and upon detecting such scenario, the system programmatically suggests that each group stay in their respective rooms due to the added cleaning burden.

The features of the invention described in embodiments herein allow meeting rooms to be adequately cleaned, e.g., fully sanitized, between meeting room usage by taking into account an imprint of the previous occupying group. This significantly reduces the risk of spreading illness/dirtiness/infection to future occupants of the same meeting room.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

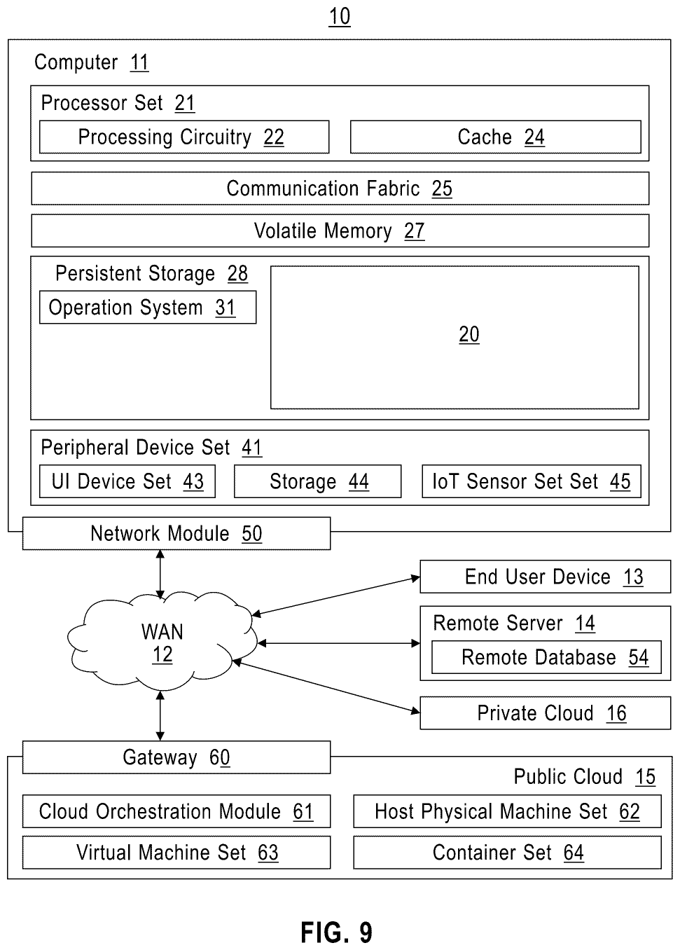

As shown in FIG. 9, computing environment 10 contains an example of an environment for the execution of at least some of the computer code involved in performing the inventive methods, such as the improved resource reservation and cleaning reservation method 20 that determines a level of risk for a group or resource based on determined relationships and other factors that is used to more effectively reserve and clean a shared resource (e.g., a group meeting room) while minimizing risk and cross contamination between groups and people, and to make sure a suitable cleaning time is accounted for based on the determined level of risk. In addition to block 20, computing environment 10 includes, for example, computer 11, wide area network (WAN) 12, end user device (EUD) 13, remote server 14, public cloud 15, and private cloud 16. In this embodiment, computer 11 includes processor set 21 (including processing circuitry 22 and cache 24), communication fabric 25, volatile memory 27, persistent storage 28 (including operating system 31 and block 20, as identified above), peripheral device set 42 (including user interface (UI) device set 43, storage 44, and Internet of Things (IoT) sensor set 45), and network module 50. Remote server 14 includes remote database 54. Public cloud 16 includes gateway 60, cloud orchestration module 61, host physical machine set 62, virtual machine set 63, and container set 64.

Computer 11 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 54. As is well understood in the art of computer technology, and depending upon the technology, performance of a computer-implemented method may be distributed among multiple computers and/or between multiple locations. On the other hand, in this presentation of computing environment 10, detailed discussion is focused on a single computer, specifically computer 11, to keep the presentation as simple as possible. Computer 11 may be located in a cloud, even though it is not shown in a cloud in FIG. 9. On the other hand, computer 11 is not required to be in a cloud except to any extent as may be affirmatively indicated.

Processor Set 21 includes one, or more, computer processors of any type now known or to be developed in the future. Processing circuitry 22 may be distributed over multiple packages, for example, multiple, coordinated integrated circuit chips. Processing circuitry 22 may implement multiple processor threads and/or multiple processor cores. Cache 24 is memory that is located in the processor chip package(s) and is typically used for data or code that should be available for rapid access by the threads or cores running on processor set 21. Cache memories are typically organized into multiple levels depending upon relative proximity to the processing circuitry. Alternatively, some, or all, of the cache for the processor set may be located “off chip.” In some computing environments, processor set 21 may be designed for working with qubits and performing quantum computing.

Computer readable program instructions are typically loaded onto computer 11 to cause a series of operational steps to be performed by processor set 21 of computer 11 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 24 and the other storage media discussed below. The program instructions, and associated data, are accessed by processor set 21 to control and direct performance of the inventive methods. In computing environment 10, at least some of the instructions for performing the inventive methods may be stored in block 20 in persistent storage 28.

Communication Fabric 25 is the signal conduction path that allows the various components of computer 11 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 27 is any type of volatile memory now known or to be developed in the future. Examples include dynamic type random access memory (RAM) or static type RAM. Typically, volatile memory 27 is characterized by random access, but this is not required unless affirmatively indicated. In computer 11, the volatile memory 27 is located in a single package and is internal to computer 11, but, alternatively or additionally, the volatile memory may be distributed over multiple packages and/or located externally with respect to computer 11.

Persistent Storage 28 is any form of non-volatile storage for computers that is now known or to be developed in the future. The non-volatility of this storage means that the stored data is maintained regardless of whether power is being supplied to computer 11 and/or directly to persistent storage 28. Persistent storage 28 may be a read only memory (ROM), but typically at least a portion of the persistent storage allows writing of data, deletion of data and re-writing of data. Some familiar forms of persistent storage include magnetic disks and solid state storage devices. Operating system 31 may take several forms, such as various known proprietary operating systems or open source Portable Operating System Interface-type operating systems that employ a kernel. The code included in block 20 typically includes at least some of the computer code involved in performing the inventive methods.

Peripheral Device Set 41 includes the set of peripheral devices of computer 11. Data communication connections between the peripheral devices and the other components of computer 11 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 43 may include components such as a display screen, speaker, microphone, wearable devices (such as goggles and smart watches), keyboard, mouse, printer, touchpad, game controllers, and haptic devices. Storage 44 is external storage, such as an external hard drive, or insertable storage, such as an SD card. Storage 44 may be persistent and/or volatile. In some embodiments, storage 44 may take the form of a quantum computing storage device for storing data in the form of qubits. In embodiments where computer 11 is required to have a large amount of storage (for example, where computer 11 locally stores and manages a large database) then this storage may be provided by peripheral storage devices designed for storing very large amounts of data, such as a storage area network (SAN) that is shared by multiple, geographically distributed computers. IoT sensor set 45 is made up of sensors that can be used in Internet of Things applications. For example, one sensor may be a thermometer and another sensor may be a motion detector.

Network Module 50 is the collection of computer software, hardware, and firmware that allows computer 11 to communicate with other computers through WAN 12. Network module 50 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 50 are performed on the same physical hardware device. In other embodiments (for example, embodiments that utilize software-defined networking (SDN)), the control functions and the forwarding functions of network module 50 are performed on physically separate devices, such that the control functions manage several different network hardware devices. Computer readable program instructions for performing the inventive methods can typically be downloaded to computer 11 from an external computer or external storage device through a network adapter card or network interface included in network module 50.

WAN 12 is any wide area network (for example, the internet) capable of communicating computer data over non-local distances by any technology for communicating computer data, now known or to be developed in the future. In some embodiments, the WAN 12 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 13 is any computer system that is used and controlled by an end user (for example, a customer of an enterprise that operates computer 11), and may take any of the forms discussed above in connection with computer 11. EUD 13 typically receives helpful and useful data from the operations of computer 11. For example, in a hypothetical case where computer 11 is designed to provide a recommendation to an end user, this recommendation would typically be communicated from network module 50 of computer 11 through WAN 12 to EUD 13. In this way, EUD 13 can display, or otherwise present, the recommendation to an end user. In some embodiments, EUD 13 may be a client device, such as thin client, heavy client, mainframe computer, desktop computer and so on.

Remote Server 14 is any computer system that serves at least some data and/or functionality to computer 11. Remote server 14 may be controlled and used by the same entity that operates computer 11. Remote server 14 represents the machine(s) that collect and store helpful and useful data for use by other computers, such as computer 11. For example, in a hypothetical case where computer 11 is designed and programmed to provide a recommendation based on historical data, then this historical data may be provided to computer 11 from remote database 54 of remote server 14.

Public Cloud 15 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 15 is performed by the computer hardware and/or software of cloud orchestration module 61. The computing resources provided by public cloud 15 are typically implemented by virtual computing environments that run on various computers making up the computers of host physical machine set 62, which is the universe of physical computers in and/or available to public cloud 15. The virtual computing environments (VCEs) typically take the form of virtual machines from virtual machine set 63 and/or containers from container set 64. It is understood that these VCEs may be stored as images and may be transferred among and between the various physical machine hosts, either as images or after instantiation of the VCE. Cloud orchestration module 61 manages the transfer and storage of images, deploys new instantiations of VCEs and manages active instantiations of VCE deployments. Gateway 60 is the collection of computer software, hardware, and firmware that allows public cloud 15 to communicate through WAN 12.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private Cloud 16 is similar to public cloud 15, except that the computing resources are only available for use by a single enterprise. While private cloud 16 is depicted as being in communication with WAN 12, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 15 and private cloud 16 are both part of a larger hybrid cloud.

As used herein, the singular forms “a”, “an” and “the” are intended to include the plural forms as well, unless the context clearly indicates otherwise. It will be further understood that the terms “comprises” and/or “comprising.” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment and terminology were chosen and described in order to best explain the principles of the invention and the practical application, and to enable others of ordinary skill in the art to understand the invention for various embodiments with various modifications as are suited to the particular use contemplated.

What is claimed is:

1. A method comprising:
receiving, at a hardware processor of a computing system, one or more requests for scheduling meetings of individuals in a group meeting in a determined meeting room;
detecting, by the hardware processor, a first group meeting request and a second group meeting request scheduled for the same meeting room in succession;
gathering, at the hardware processor, information about participants of at least the first group meeting, and determining one or more relationships between one or more participants of the first group meeting and non-participants of the first group meeting, and
for each relationship, determining an associated physical distance measure between the participants of the relationship;
computing, by the hardware processor, based on the determined one or more relationships and associated physical distance measures, a level of risk score representing a risk of illness or dirtiness;
determining, by the hardware processor, an amount of time required for the meeting room to become clean between the first meeting and second meeting based on the level of risk score; and
automatically scheduling a break of the determined amount of time between the first group meeting and second group meeting at the meeting room.

2. The method of claim 1, wherein the computed level of risk score is further based on a participant's characteristics information, said gathered information further comprising the participant's characteristics information, wherein the participant's characteristics information comprises one or more of:
a health condition of the participant;
a current illness or sick day of the participant;
a detected recent vacation abroad by the participant; and
a degree to which the participants have recently been physically in close contact with each other.

3. The method of claim 1, wherein the computed level of risk score is further based on features of the meeting room, said gathered information further comprising the features of the meeting room, said features of the meeting room comprising one or more of:
physical elements of the meeting room that invite physical contact of participants; and
a layout of the meeting room defining whether or not the participants are likely or able to locate spread out or cluster within the meeting room.

4. The method of claim 3, further comprising:
determining, by the hardware processor, a contact risk level score for a participant, the contact risk level score based on relationships between the participants in a same or different group, the determined associated physical distances between participant's and the participant's characteristics; and
determining, by the hardware processor, a meeting room level risk score based on a sum of weighted contact risk level scores of all participants of the same or different group.

5. The method of claim 4, further comprising:
computing, by the hardware processor, a group-to-group level risk score based on a degree of overlapping and non-overlapping participants in the first group meeting and second group meeting; and
modifying, by the hardware processor, the meeting room level of risk score based on the computed group-to-group score.

6. The method of claim 1, further comprising:
scheduling, by the hardware processor, for the break, an active manual physical cleaning of the meeting room, an autonomous cleaning of the meeting room, or a cleaning by a period of non-use of the meeting room.

7. The method of claim 1, further comprising:
tracking, by an identification system, a current presence of the participants and actions of the participants at the time of the first group meeting; and
modifying, by the hardware processor, said level of risk score based on a current absence or current action of the participant.

8. A computer program product comprising:
a computer readable storage medium having program instructions embodied therewith, the program instructions executable by a computer system to cause the computer system to:
receive, at the computer system, one or more requests for scheduling meetings of individuals in a group meeting in a meeting room;
detect, by the computer system, a first group meeting request and a second group meeting request scheduled for the same meeting room in succession;
gather, by the computer system, information about participants of at least the first group meeting, and determine one or more relationships between one or more participants of the first group meeting and between participants of the first group meeting and non-participants of the group meeting, and
for each relationship, determine an associated physical distance measure between the participants of the relationship;
compute, by the computer system, based on the determined one or more relationships and associated physical distance measures, a level of risk score representing a risk of illness or dirtiness;
determine, by the computer system, an amount of time required for the meeting room to become clean between the first group meeting and second group meeting based on the level of risk score; and
automatically schedule, by the hardware processor, a break of the determined amount of time between the first meeting and second meeting at the meeting room.

9. The computer program product of claim 8, wherein the computed level of risk score is further based on a participant's characteristics information, the program instructions further causing the computer system to gather the participant's characteristics information, the participant's characteristics information comprising one or more of:
a health condition of the participant;
a current illness or sick day of the participant;
a detected recent vacation abroad by the participant; and
a degree to which the participants have recently been physically in close contact with each other.

10. The computer program product of claim 9, wherein the computed level of risk score is further based on features of the meeting room, wherein the program instructions further cause the computer system to gather data representing features of the meeting room, the features comprising one or more of:
physical elements of the meeting room that invite physical contact of participants; and
a layout of the meeting room defining whether or not the participants are likely or able to locate spread out or cluster within the meeting room.

11. The computer program product of claim 10, wherein to compute the level of risk score, said program instructions further cause the computer system to:
determine, by the computer system, a contact risk level score for a participant, the contact risk level score based on relationships between the participants in a same or different group, the determined associated physical distances between participant's and the participant's characteristics; and
determine, by the computer system, a meeting room level risk score based on a sum of weighted contact risk level scores of all participants of the same or different group.

12. The computer program product of claim 11, wherein to compute the level of risk score, said program instructions further cause the computer system to:
compute, by the computer system, a group-to-group level risk score based on a degree of overlapping and non-overlapping participants in the requested first group meeting and second group meeting; and
modify, by the computer system, the meeting room level of risk score based on the computed group-to-group score.

13. The computer program product of claim 8, wherein the program instructions further cause the computer system to:
schedule, by the computer system, for the break, one of: an active manual physical cleaning of the meeting room, an autonomous cleaning of the meeting room, or a cleaning by a period of non-use of the meeting room.

14. The computer program product of claim 8, wherein the program instructions further cause the computer system to:
track, by an identification system, a current presence of the participants and actions of the participants at the time of the first group meeting; and
modify, by the computing system, said level of risk score based on a current absence or current action of the participant.

15. A system comprising:
a hardware processor;
a computer readable storage medium having program instructions embodied therewith, the program instructions executable by the hardware processor to cause the hardware processor to:
receive one or more requests for scheduling meetings of individuals in a group meeting in a meeting room;
detect a first group meeting request and a second group meeting request scheduled for the same meeting room in succession;
gather information about participants of at least the first group meeting, and determine one or more relationships between one or more participants of the first group meeting and between participants of the first group meeting and non-participants of the group meeting, and
for each relationship, determine an associated physical distance measure between the participants of the relationship;
compute, based on the determined one or more relationships and associated physical distance measures, a level of risk score representing a risk of illness or dirtiness;
determine an amount of time required for the meeting room to become clean between the first meeting and second meeting based on the level of risk score; and
automatically schedule a break of the determined amount of time between the first group meeting and second group meeting at the meeting room.

16. The system of claim 15, wherein the computed level of risk score is further based on one or more of: a participant's characteristics information, or features of the meeting room, said gathered information further comprising the participant's characteristics information, the participant's characteristics information comprising one or more of:
a health condition of the participant;
a current illness or sick day of the participant;
a detected recent vacation abroad by the participant; and
a degree to which the participants have recently been physically in close contact with each other; and the said gathered information further comprising the features of the meeting room, the features of the meeting room comprising one or more of:
physical elements of the meeting room that invite physical contact of participants; and
a layout of the meeting room defining whether or not the participants are likely or able to locate spread out or cluster within the meeting room.

17. The system of claim 16, wherein to compute the level of risk score, said hardware processor is further configured to:
determine a contact risk level score for a participant, the contact risk level score based on relationships between the participants in a same or different group, the determined associated physical distances between participant's and the participant's characteristics; and
determine, by the computer system, a meeting room level risk score based on a sum of weighted contact risk level scores of all participants of the same or different group.

18. The system of claim 17, said hardware processor is further configured to:
compute, by the computer system, a group-to-group level risk score based on a degree of overlapping and non-overlapping participants in the requested first group meeting and second group meeting; and
modify, by the computer system, the meeting room level of risk score based on the computed group-to-group score.

19. The system of claim 15, wherein the hardware processor is further configured to:
schedule, for the break, one of: an active manual physical cleaning of the meeting room, an autonomous cleaning of the meeting room, or a cleaning by a period of non-use of the meeting room.

20. The system of claim 15, wherein the hardware processor is further configured to:
track, by an identification system, a current presence of the participants and actions of the participants at the time of the first group meeting; and
modify, by the hardware processor, said level of risk score based on a current absence or current action of the participant.
